(19) United States
(12) Patent Application Publication
(10) Pub. No.: US 2025/0153752 A1
(43) Pub. Date: May 15, 2025

(54) METHOD OF DEPARTURE MANAGEMENT OF AUTOMATED GUIDED VEHICLE AND DEPARTURE MANAGEMENT SYSTEM OF AUTOMATED GUIDED VEHICLE FOR PERFORMING THE SAME

(71) Applicants: YONGGU KIM, Yongin-si (KR); SANGHOON JI, Yongin-si (KR)

(72) Inventors: YONGGU KIM, Yongin-si (KR); SANGHOON JI, Yongin-si (KR)

(21) Appl. No.: 18/389,541

(22) Filed: Nov. 14, 2023

(30) Foreign Application Priority Data
Nov. 23, 2022 (KR) 10-2022-0158522

(51) Int. Cl. G05D 1/644; G05D 1/698; G05D 107/70

(52) U.S. Cl. CPC B61L 99/002; G05D 1/648

(57) ABSTRACT

A method of departure management of an automated guided vehicle and a departure management system of an automated guided vehicle for performing the same estimates a first moving time which is a moving time of a reference automated guided vehicle from a current point to a destination point, and a limit waiting time, and adjust a departure time of the automated guided vehicle from the current point. In addition, when a destination point facility is out of order, the method of departure management of the automated guided vehicle and the departure management system of the automated guided vehicle for performing the same may determine a failure response command for the reference automated guided vehicle based on an estimated repair time of the destination point facility, and provide a failure response command to the reference automated guided vehicle.

This application claims priority to Korean Patent Application No. 10-2022-0158522, filed on Nov. 23, 2022, and all the benefits accruing therefrom under 35 U.S.C. § 119, the content of which in its entirety is herein incorporated by reference.

### BACKGROUND

### 1. Field

Embodiments of the present invention relate to a method of departure management of an automated guided vehicle and departure management system of an automated guided vehicle for performing the same. More particularly, embodiments of the present invention relate to a method of departure management of an automated guided vehicle and departure management system of an automated guided vehicle for performing the same managing departure of an automated guided vehicle based on real-time data.

### 2. Description of the Related Art

An automated guided vehicle is one of automation equipment used in production factory, etc., and performs work while moving according to a location where the equipment is located in the production factory, that is, according to a set layout.

The automated guided vehicle may have a vehicle body and a driving device for driving the vehicle body. The driving device includes a plurality of driving wheels installed in a lower region of the vehicle body to drive the vehicle body, and a wheel driving motor for driving the driving wheels by receiving driving force from a battery may be disposed on a side of each driving wheel. An obstacle sensor for detecting an obstacle may be installed in a front of the vehicle body.

The automated guided vehicle may include an unmanned communicator for communication with an external central controller, and an in-vehicle controller which controls driving of each wheel driving motor based on a signal detected from the obstacle sensor according to a command from the central controller received from the unmanned communicator.

The central controller may grasp situation of entire system and transmit work commands to be performed by each automated guided vehicle to each automated guided vehicle in a predetermined communication format. The automatic guided vehicle may receive the command transmitted from the central controller and move along a indicated route according to contents of instructed work command or perform instructed transportation task.

A conventional departure management system of an automated guided vehicle estimates occurrence of a work command based on past data and moves the automated guided vehicle to a starting point in advance. Therefore, the conventional departure management system of the automated guided vehicle does not reflect real-time data.

### SUMMARY

Embodiments of the present invention provide a method of departure management of an automated guided vehicle minimizing a loss of a moving time of the automated guided vehicle to a destination point based on real-time data.

Embodiments of the present invention provide a departure management system of an automated guided vehicle minimizing a loss of a moving time of the automated guided vehicle to a destination point based on real-time data.

In an embodiment of a method of departure management of an automated guided vehicle according to the present invention, the method includes: determining whether a task is assigned to a reference automated guided vehicle; extracting a starting point and a destination point of the task when the task is assigned to the reference automated guided vehicle; estimating a first moving time which is a moving time of the reference automated guided vehicle from a current point of the reference automated guided vehicle to the destination point, and a limit waiting time; determining a departure time of the reference automated guided vehicle from the current point to the destination point based on the first moving time and the limit waiting time; starting the reference automated guided vehicle from the current point and arriving at the destination point; determining whether a destination point facility is out of order; and determining a failure response command for the reference automated guided vehicle based on an estimated repair time of the destination point facility when the destination point facility is out of order.

In an embodiment, the first moving time may be estimated based on current locations and simulation times of automated guided vehicles.

In an embodiment, the first moving time may be estimated based on a previous automated guided vehicle located ahead on a route for each of the automated guided vehicles.

In an embodiment, the first moving time may be estimated based on an intersecting automated guided vehicle intersecting with the reference automated guided vehicle at an intersection point.

In an embodiment, an automated guided vehicle having a longer simulation time among the reference automated guided vehicle and the intersecting automated guided vehicle may acquire a priority.

In an embodiment, the first moving time may include a second moving time which is a moving time of the reference automated guided vehicle from the current point to the starting point, and a third moving time which is a moving time of the reference automated guided vehicle from the starting point to the destination point.

In an embodiment, the current point may be a waiting point where the reference automated guided vehicle waits before being assigned the task.

In an embodiment, the method may further include loading an object at the starting point and waiting for a confirmation of the destination point, and the current point may be not a waiting point where the reference automated guided vehicle waits before being assigned the task but the starting point.

In an embodiment, the limit waiting time may be estimated based on the number of lot panels and a tact time.

In an embodiment, the limit waiting time may be determined by multiplying the number of lot panels, and the tact time.

In an embodiment, the method may further include: determining a spare time based on the first moving time and the limit waiting time, and the spare time may be determined by subtracting the first moving time from the limit waiting time.

In an embodiment, the method may further include determining a spare time based on the first moving time and the limit waiting time, and as the spare time is shorter, the departure time may be earlier.

In an embodiment, when the estimated repair time is equal to or less than a first reference value, the reference automated guided vehicle may wait at the destination point until the estimated repair time passes.

In an embodiment, when the estimated repair time is greater than the first reference value and is less than or equal to a second reference value, the reference automated guided vehicle may wander around the destination point.

In an embodiment, when the estimated repair time is greater than the second reference value, the reference automated guided vehicle may move to the starting point.

In an embodiment, the method may further include unloading an object at the destination point when the destination point facility is not out of order.

In an embodiment, the method may further include designating a limited number of the automated guided vehicles for each of routes from the current point to the destination point.

In an embodiment of a departure management system of an automated guided vehicle according to the present invention, the departure management system includes: automated guided vehicles and a controller for communicating with the automated guided vehicles. The controller is configured to determine whether a task is assigned to a reference automated guided vehicle of the automated guided vehicles, extract a starting point and a destination point of the task when the task is assigned to the reference automated guided vehicle, estimate a first moving time which is a moving time of the reference automated guided vehicle from a current point of the reference automated guided vehicle to the destination point, and a limit waiting time, determine a departure time of the reference automated guided vehicle from the current point to the destination point based on the first moving time and the limit waiting time, determine whether a destination point facility is out of order, and determine a failure response command for the reference automated guided vehicle based on an estimated repair time of the destination point facility when the destination point facility is out of order.

In an embodiment, the first moving time may be estimated based on current locations and simulation times of the automated guided vehicles.

In an embodiment, the limit waiting time may be estimated based on the number of lot panels and a tact time.

A method of departure management of an automated guided vehicle and a departure management system of an automated guided vehicle for performing the same according to embodiments of the present invention may estimate a first moving time which is a moving time of a reference automated guided vehicle from a current point to a destination point, and a limit waiting time, and adjust a departure time of the automated guided vehicle from the current point. In addition, when a destination point facility is out of order, the method of departure management of the automated guided vehicle and the departure management system of the automated guided vehicle for performing the same may determine a failure response command for the reference automated guided vehicle based on an estimated repair time of the destination point facility, and provide a failure response command to the reference automated guided vehicle. Therefore, a loss of a time required for the automated guided vehicle to move from the current point to the destination point may be effectively minimized, and logistics congestion due to failure of the destination point facility may be effectively minimized.

### BRIEF DESCRIPTION OF THE DRAWINGS

The above and other features of embodiments of the invention will become more apparent by describing in detailed embodiments thereof with reference to the accompanying drawings, in which:

FIG. 1 is a block diagram illustrating a departure management system of an automated guided vehicle according to embodiments;

FIG. 2 is a conceptual diagram illustrating a conventional departure management system of an automated guided vehicle;

FIG. 3 is a diagram illustrating logistics congestion of an automated guided vehicle;

FIG. 4 is a flowchart illustrating a method of departure management of an automated guided vehicle performed by a departure management system of the automated guided vehicle;

FIGS. 5A and 5B are diagrams illustrating a first moving time of FIG. 4; and

FIG. 6 is a flowchart illustrating in detail a step of determining a failure response command based on an estimated repair time of a destination point facility.

### DETAILED DESCRIPTION

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein. Hereinafter, embodiments of the present invention will be described in detail with reference to the accompanying drawings.

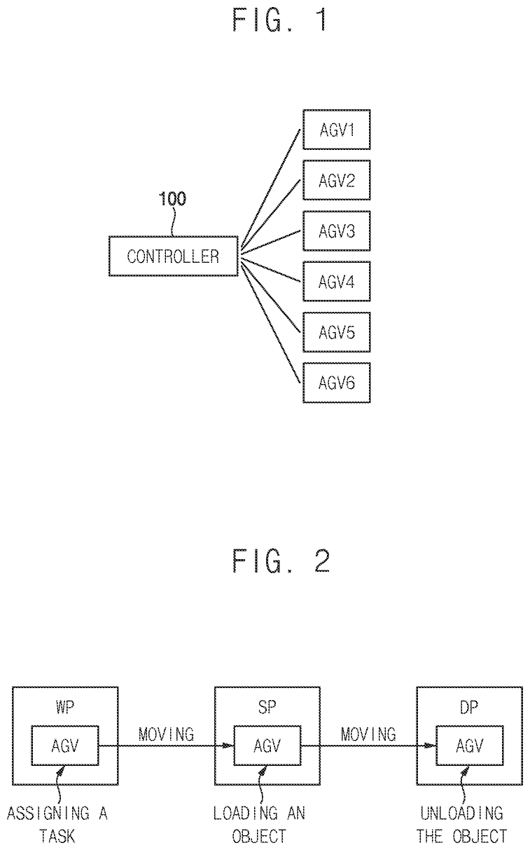

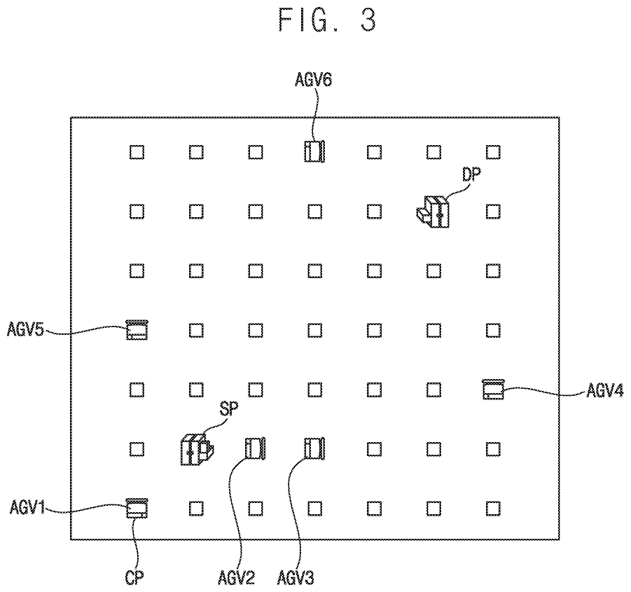

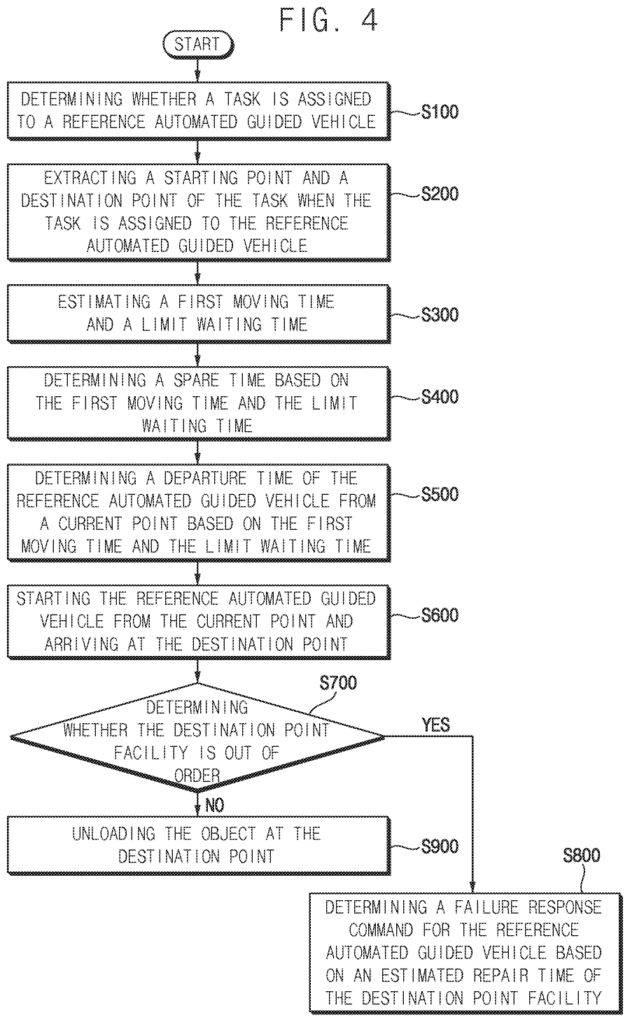

FIG. 1 is a block diagram illustrating a departure management system of an automated guided vehicle according to embodiments. FIG. 2 is a conceptual diagram illustrating a conventional departure management system of an automated guided vehicle. FIG. 3 is a diagram illustrating logistics congestion of an automated guided vehicle.

Referring to FIG. 1, a departure management system of an automated guided vehicle may include automated guided vehicles AGV1, AGV2, AGV3, AGV4, AGV5, and AGV6 and a controller 100 communicating with the automated guided vehicles AGV1, AGV2, AGV3, AGV4, AGV5, and AGV6.

FIG. 1 shows six automated guided vehicles AGV1, AGV2, AGV3, AGV4, AGV5, and AGV6, but this corresponds to an example, and the present invention is not limited to the number of automated guided vehicles in the departure management system of the automated guided vehicle. The departure management system of the automated guided vehicle may include more than the six unmanned guided vehicles. Alternatively, the departure management system of the automated guided vehicle may include fewer than the six unmanned guided vehicles.

The controller 100 may determine whether a task is assigned to a reference automated guided vehicle. Here, the reference automated guided vehicle means an automated guided vehicle which performs the task, and the controller 100 may estimate a moving time of move the reference automated guided vehicle from a current point to a destination point, and logistics congestion in consideration of an operation of other automated guided vehicles other than the reference unmanned guided vehicle.

Referring to FIG. 2, a conventional reference automated guided vehicle may wait at a waiting point WP before being assigned the task from the controller 100. The waiting point WP may be a point at which the reference automated guided vehicle stops and waits before being assigned the task. When the reference automated guided vehicle is assigned the task from the controller 100, the reference automated guided vehicle may move to the starting point SP. The starting point SP may be a point at which the reference automated guided vehicle loads an object and departs to the destination point DP.

When the reference automated guided vehicle arrives at the starting point SP, the object may be loaded onto the reference automated guided vehicle. When the object are loaded on the reference automated guided vehicle at the starting point SP, the reference automated guided vehicle may move to the destination point DP The destination point DP may be a point where the reference automated guided vehicle loaded with the object finally unloads the object.

When the reference automated guided vehicle arrives at the destination point DP, the reference automated guided vehicle may unload the object.

Referring to FIG. 3, the automated guided vehicles AGV1, AGV2, AGV3, AGV4, AGV5 and AGV6 may load the object at the starting point SP and move to the destination point DP Depending on a route, there may be a point where a plurality of automated guided vehicles AGV1, AGV2, AGV3, AGV4, AGV5 and AGV6 exist. In an embodiment, for example, the automated guided vehicles AGV1, AGV2, AGV3, AGV4, AGV5 and AGV6 may be located at a corner point and a route convergence point.

A conventional departure management system of the automated guided vehicle may estimate an occurrence of an order based on past data and move the automated guided vehicle to the starting point SP in advance. Therefore, the conventional departure management system of the automated guided vehicles does not reflect real-time data. In order to minimize a loss of a moving time of the automated guided vehicle to move from the waiting point WP to the destination point DP, the departure management system of the automated guided vehicle needs to reflect real-time data (e.g., a limit waiting time and the logistics congestion).

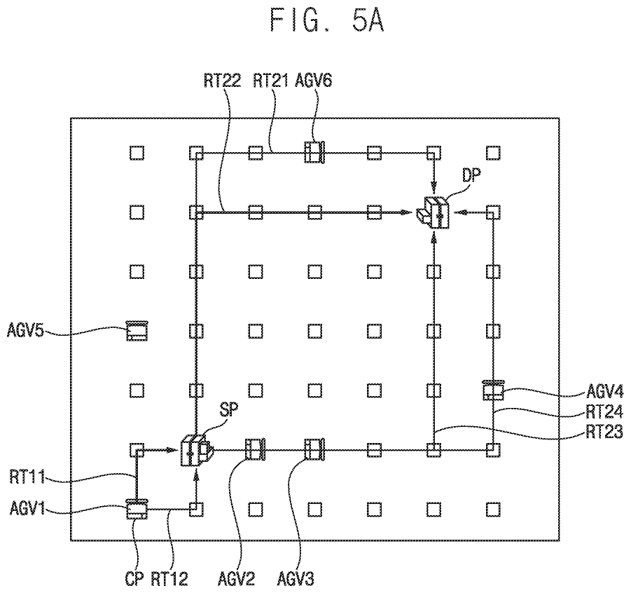

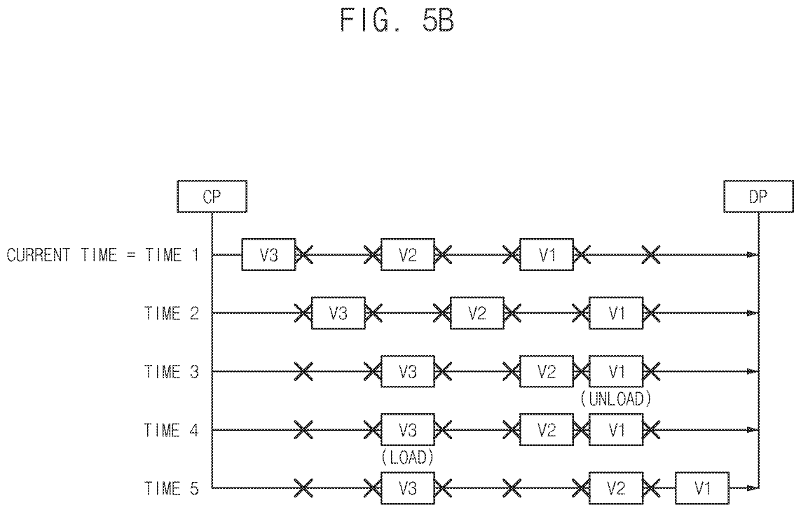

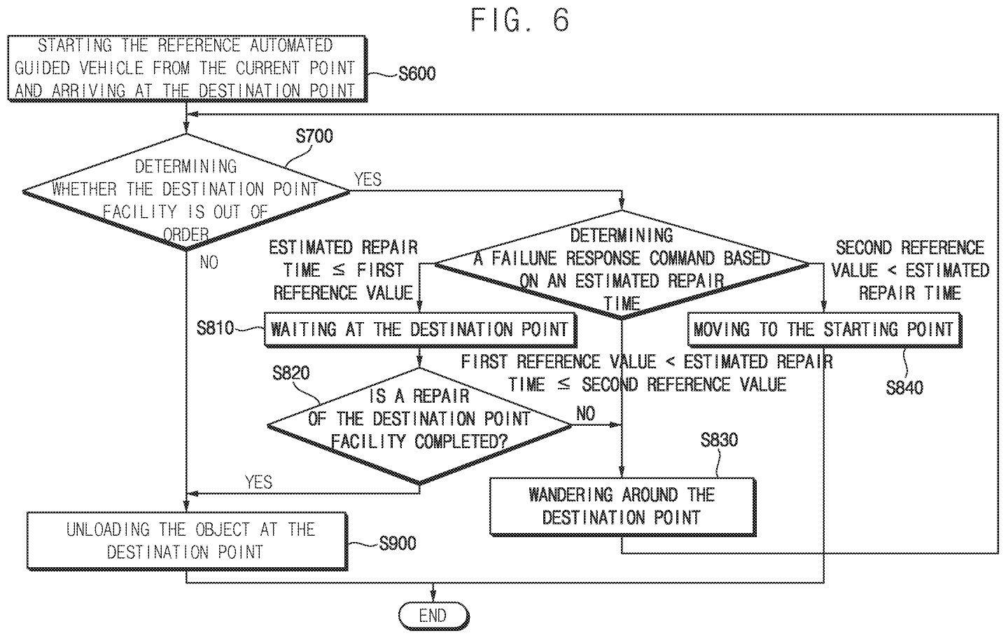

FIG. 4 is a flowchart illustrating a method of departure management of an automated guided vehicle performed by a departure management system of the automated guided vehicle. FIGS. 5A and 5B are diagrams illustrating a first moving time of FIG. 4. FIG. 6 is a flowchart illustrating in detail a step of determining a failure response command based on an estimated repair time of a destination point facility.

Referring to FIGS. 1 to 6, a method of departure management of an automated guided vehicle may include determining whether a task is assigned to a reference automated guided vehicle (S100), extracting a starting point SP and a destination point DP of the task when the task is assigned to the reference automated guided vehicle (S200), estimating a first moving time which is a moving time of the reference automated guided vehicle from a current point CP of the reference automated guided vehicle to the destination point DP, and a limit waiting time (S300), determining a spare time based on the first moving time and the limit waiting time (S400), determining a departure time of the reference automated guided vehicle from the current point CP based on the first moving time and the limit waiting time (S500), starting the reference automated guided vehicle from the current point CP and arriving at the destination point DP (S600), determining whether a destination point facility is out of order (S700), and determining a failure response command for the reference automated guided vehicle based on an estimated repair time of the destination point facility when the destination point facility is out of order (S800).

The method may include: determining whether the task is assigned to the reference automated guided vehicle (S100), extracting the starting point SP and the destination point DP of the task when the task is assigned to the reference automated guided vehicle (S200), and estimating the first moving time which is the moving time of the reference automated guided vehicle from the current point CP to the destination point DP, and the limit waiting time (S300).

The controller 100 may determine whether the task is assigned to the reference unmanned guided vehicle. The controller 100 may extract the starting point SP and the destination point DP of the task when the task is assigned to the reference automated guided vehicle. The controller 100 may determine whether routes from the current point CP to the starting point SP are plural, and whether routes from the starting point SP to the destination point DP are plural. The current point CP may be a current location of the reference automated guided vehicle when the task is allocated to the reference automated guided vehicle.

When there is only one route from the current point CP to the starting point SP or from the starting point SP to the destination point DP, the controller 100 may determine the one route as a final route of the reference automated guided vehicle. On the other hand, when there are multiple routes, the controller 100 may estimate a moving time of the reference guided vehicle for each candidate route and determine the shortest route among the candidate routes as the final route of the reference guided vehicle. The first moving time may be a moving time of the reference automated guided vehicle for the shortest time route from the current point CP to the destination point DR The first moving time may include a second moving time which is a moving time of the reference automated guided vehicle from the current point CP to the starting point SP, and a third moving time which is a moving time of the reference automated guided vehicle from the starting point SP to the destination point DP.

The controller 100 may determine a current location of the automated guided vehicles AGV1, AGV2, AGV3, AGV4, AGV5 and AGV6. In addition, the controller 100 may determine a simulation time required for the automated guided vehicles AGV1, AGV2, AGV3, AGV4, AGV5 and AGV6 to perform tasks. The first moving time may be estimated based on the current location and the simulation times of the automated guided vehicles.

In a process of determining the final route, the controller 100 may check a previous automated guided vehicle located ahead on a route for each of the automated guided vehicles AGV1, AGV2, AGV3, AGV4, AGV5 and AGV6. The first moving time may be estimated based on the previous automated guided vehicle located ahead on a route for each of the automated guided vehicles AGV1, AGV2, AGV3, AGV4, AGV5, and AGV6.

In the process of determining the final route, the controller 100 may check the reference automated guided vehicle and an intersecting automated guided vehicle intersecting with the reference automated guided vehicle at an intersection point. The first moving time may be estimated based on the reference automated guided vehicle and intersecting automated guided vehicle intersecting with the reference automated guided vehicle at the intersection point.

The method may further include designating a limited number of the automated guided vehicles for each of routes from the current point CP to the destination point DP In order to minimize congestion on each of the routes, the limited number of the automated guided vehicles may be designated for each of the routes. In an embodiment, for example, depending on the route, the limited number of the automated guided vehicles may be three.

The controller 100 may accurately estimate a moving time of the reference automated guided vehicle based on real-time data for the simulation time of other automated guided vehicles AGV1, AGV2, AGV3, AGV4, AGV5, and AGV6 and a working location, and determine an optimal path of the reference automated guided vehicle. Therefore, the first moving time may be estimated based on the current location and the simulation time of the automated guided vehicles AGV1, AGV2, AGV3, AGV4, AGV5, and AGV6.

In FIG. 5A, the departure management system of the automated guided vehicle may include six automated guided vehicles AGV1, AGV2, AGV3, AGV4, AGV5, and AGV6, and the automated guided vehicles AGV1, AGV2, AGV3, AGV4, AGV5, and AGV6 may move from the current point CP to the destination point DP.

In FIG. 5A, there may be two paths on which a first automated guided vehicle AGV1 moves from the current point CP to the starting point SP: a first path RT11 and a second path RT12. The controller 100 may determine the shortest path among the first path RT11 and the second path RT12 as an optimal path along which the first automated guided vehicle AGV1 moves from the current point CP to the starting point SP.

In FIG. 5A, a path along which the first automated guided vehicle AGV1 moves from the starting point SP to the destination point DP includes a third path RT21, a fourth path RT22, a fifth path RT23, and a sixth path RT24. The controller 100 may determine the shortest path among the third path RT21, the fourth path RT22, the fifth path RT23, and the sixth path RT24 as an optimal path of the first automated guided vehicle AGV1 moving from the starting point SP to the destination point DP.

The controller 100 may calculate the first moving time. The controller 100 may calculate the second moving time and the third moving time. The controller 100 may divide a time frame into specific time units. In an embodiment, for example, the controller 100 may divide the time frame in units of 1 second. The automated guided vehicle may not overtake a previous automated guided vehicle when there is the previous automated guided vehicle located ahead on a route. In addition, when automated guided vehicles pass through one intersection, the controller 100 may designate a priority among the automated guided vehicles. Among the automated guided vehicles, the automated guided vehicle having the longest simulation time may obtain priority to cross the intersection. That is, an automated guided vehicle having a longer simulation time among the reference automated guided vehicle and the intersecting automated guided vehicle may acquire the priority.

In a first time TIME 1 of FIG. 5B, an automated guided vehicle V1, an automated guided vehicle V2, and an automated guided vehicle V3 may be sequentially located between the current point CP and the destination point DP Here, the automated guided vehicle V1 is in the front, the automated guided vehicle V3 is in the back, the automated guided vehicle V2 is in the middle, and the automated guided vehicle V2 is illustrated as a reference unmanned guided vehicle which performs a task from the current point CP to the destination point DP, for example.

In a second time TIME 2 of FIG. 5B, the automated guided vehicle V1, the automated guided vehicle V2, and the automated guided vehicle V3 may each move in a direction to the destination point DP by one control point. The control point may be a minimum unit distance which the guided vehicle moves.

In the third time TIME 3 of FIG. 5B, the automated guided vehicle V1 may stop and unload the object. At this time, the automated guided vehicle V2 and the automated guided vehicle V3 may each further move toward the destination point DP by the one control point.

In the fourth time TIME 4 of FIG. 5B, the automated guided vehicle V1 may stop after unloading the object. At this time, the automated guided vehicle V2 may not move any further due to the automated guided vehicle V1 and may stay at the location of the third time TIME 3. The automated guided vehicle V3 may exemplify a case of stopping to load the object at the fourth time TIME 4.

In the fifth time TIME 5 of FIG. 5B, the guided vehicle V1 and the guided vehicle V2 may each move toward the direction to the destination point DP by the one control point. In the fifth time TIME 5, the automated guided vehicle V3 may be preparing to move after loading the object.

In an embodiment, the current point CP may be a waiting point WP. In an embodiment, for example, the reference guided vehicle may wait at the waiting point WP when assigned a task.

In an embodiment, the method may further include loading the object at the starting point SP and waiting for a confirmation of the destination point DP. At this time, the current point CP may not be the waiting point WP but the starting point SP. Specifically, in order to reduce the first moving time, the controller 100 may allow the automated guided vehicle to load the object at the starting point SP, to move the object to the destination point DP, and to wander around and wait for the confirmation of the destination point DP until the automated guided vehicle receives the confirmation of the destination point DP.

As such, the controller 100 may estimate the first moving time in consideration of the shortest time path, current locations of the automatic guided vehicles AGV1, AGV2, AGV3, AGV4, AGV5, and AGV6, and the simulation time.

In an embodiment, the reference automated guided vehicle may have to arrive at the destination point DP within a limit waiting time. The limit waiting time may be a time required for the destination point facility to perform a current task of the destination point facility. In other words, the limit waiting time may be a time required for the automated guided vehicle to arrive at the destination point DP so that the destination point facility finishes the current task of the destination point facility in order to continuously operate the destination point facility.

The destination point facility may be a facility at the destination point DP for unloading the object transported by the reference automated guided vehicle to the destination point DP In an embodiment, for example, the object transported by the reference automated guided vehicle may be a panel, and the reference automated guided vehicle may carry 10 panels. In an embodiment, for example, the destination point facility may unload the 10 panels transported by the reference automated guided vehicle. However, this is an example, and the object transported by the reference automated guided vehicle is not limited to the panel.

The limit waiting time may be estimated based on the number of lot panels, and a tact time. The limit waiting time may be determined by multiplying the number of lot panels and the tact time. The number of lot panels may be the number of the object which the destination point facility processes at one time. The tact time may be a time required for a destination point facility to unload one lot panel. In an embodiment, for example, when the number of lot panels is 10 and the tact time is 1 minute, the limit waiting time may be 10 minutes.

The method may include determining the spare time based on the first moving time and the limit waiting time (S400), determining the departure time of the reference automated guided vehicle from the current point CP based on the first moving time and the limit waiting time (S500).

The controller 100 may set a priority among the automated guided vehicles AGV1, AGV2, AGV3, AGV4, AGV5, and AGV6 based on the first moving time and the limit waiting time for a continuous operation of the destination point facility. Departure times of the automated guided vehicles AGV1, AGV2, AGV3, AGV4, AGV5 and AGV6 from the current point CP may be determined according to the priority. In an embodiment, for example, the spare time may be determined based on the first moving time and the limit waiting time. The spare time may be determined by subtracting the moving time from the limit waiting time. As the spare time is shorter, the departure time may be earlier.

In an embodiment, for example, when a limit waiting time of the first automated guided vehicle AGV1 is 2 minutes and a first moving time of the first automated guided vehicle AGV1 is 1 minute, a spare time of the first automatic guided vehicle AGV1 may be 1 minute. In an embodiment, for example, when a limit waiting time of the second automated guided vehicle AGV2 is 4 minutes and a first moving time of the second automated guided vehicle AGV2 is 2 minutes, a spare time of the second automatic guided vehicle AGV2 may be 2 minutes. In an embodiment, for example, when the spare time of the first automated guided vehicle AGV1 is 1 minute and the spare time of the second automated guided vehicle AGV2 is 2 minutes, the first automated guided vehicle AGV1 may obtain a priority over the second automated guided vehicle AGV2. Therefore, a departure time of the first automated guided vehicle AGV1 from the current point CP may be equal to or earlier than a departure time of the second automated guided vehicle AGV2.

The method may include: starting the reference automated guided vehicle from the current point CP and arriving at the destination point DP (S600), determining whether the destination point facility is out of order (S700), and determining a failure response command for the reference automated guided vehicle based on an estimated repair time of the destination point facility when the destination point facility is out of order (S800).

In FIG. 4, the reference automated guided vehicle may depart from the current point CP and arrive at the destination point DP. In an embodiment, the method may further include: unloading the object at the destination point DP when the destination point facility is not out of order (S900). When the destination point facility is out of order, the reference automated guided vehicle may not be able to unload the object at the destination point DP as soon as the reference automated guided vehicle arrives at the destination point DP. Therefore, the controller 100 may determine the failure response command for the reference automated guided vehicle based on the estimated repair time of the destination point facility, and provide the failure response command to the reference automated guided vehicle.

Referring to FIG. 6, when the estimated repair time is equal to or less than a first reference value, the reference automated guided vehicle may wait at the destination point DP until the estimated repair time passes (S810). The first reference value may be a time enough that a repair time is short and does not affect the logistics congestion. Therefore, the reference automated guided vehicle may wait at the destination point DP until the repair time.

When repair of the destination point facility is completed (S820) while the reference automated guided vehicle is waiting at the destination point DP (S810), the reference automated guided vehicle may unload the object at the destination point DP (S900).

When the estimated repair time is greater than the first reference value and is less than or equal to a second reference value, the reference automated guided vehicle may wander around the destination point DP (S830). The second reference value may be greater than the first reference value, and may be a time sufficient to affect the logistics congestion. Therefore, in order to prevent the logistics congestion from increasing, the reference automated guided vehicle may wander around the destination point DP until the estimated repair time of the destination point facility.

When the repair of the destination point facility is not completed for a certain amount of time (S820) while the reference unmanned guided vehicle is waiting for the destination point DP (S810), the reference automated guided vehicle may wander around the destination point DP (S830) after the certain amount of time.

When the estimated repair time is greater than the second reference value, the reference automated guided vehicle may move to the starting point SP (S840). When the estimated repair time is greater than the second reference value, it may take a considerable amount of time for the reference automated guided vehicle to unload the object to the destination point DP. Therefore, the reference automated guided vehicle may move to the starting point SP and unload the object at the starting point SP.

As such, the method of departure management of the automated guided vehicle and the departure management system of the automated guided vehicle for performing the same may estimate the first moving time which is the moving time of the reference automated guided vehicle from the current point CP to the destination point DP, and the limit waiting time, and adjust the departure time of the automated guided vehicle from the current point CP. In addition, when the destination point facility is out of order, the method of departure management of the automated guided vehicle and the departure management system of the automated guided vehicle for performing the same may determine the failure response command for the reference automated guided vehicle based on the estimated repair time of the destination point facility, and provide the failure response command to the reference automated guided vehicle. Therefore, a loss of a time required for the automated guided vehicle to move from the current point CP to the destination point DP may be effectively minimized, and the logistics congestion due to failure of the destination point facility may be effectively minimized.

What is claimed is:

1. A method of departure management of an automated guided vehicle, the method comprising:
determining whether a task is assigned to a reference automated guided vehicle;
extracting a starting point and a destination point of the task when the task is assigned to the reference automated guided vehicle;
estimating a first moving time which is a moving time of the reference automated guided vehicle from a current point of the reference automated guided vehicle to the destination point, and a limit waiting time;
determining a departure time of the reference automated guided vehicle from the current point to the destination point based on the first moving time and the limit waiting time;
starting the reference automated guided vehicle from the current point and arriving at the destination point;
determining whether a destination point facility is out of order; and
determining a failure response command for the reference automated guided vehicle based on an estimated repair time of the destination point facility when the destination point facility is out of order.

2. The method of claim 1, wherein the first moving time is estimated based on current locations and simulation times of automated guided vehicles.

3. The method of claim 1, wherein the first moving time is estimated based on a previous automated guided vehicle located ahead on a route for each of automated guided vehicles.

4. The method of claim 1, wherein the first moving time is estimated based on an intersecting automated guided vehicle intersecting with the reference automated guided vehicle at an intersection point.

5. The method of claim 4, wherein an automated guided vehicle having a longer simulation time among the reference automated guided vehicle and the intersecting automated guided vehicle acquires a priority.

6. The method of claim 1, wherein the first moving time includes a second moving time which is a moving time of the reference automated guided vehicle from the current point to the starting point, and a third moving time which is a moving time of the reference automated guided vehicle from the starting point to the destination point.

7. The method of claim 1, wherein the current point is a waiting point where the reference automated guided vehicle waits before being assigned the task.

8. The method of claim 1, further comprising:
loading an object at the starting point and waiting for a confirmation of the destination point,
wherein the current point is not a waiting point where the reference automated guided vehicle waits before being assigned the task but the starting point.

9. The method of claim 1, wherein the limit waiting time is estimated based on a total number of lot panels and a tact time.

10. The method of claim 9, wherein the limit waiting time is determined by multiplying the total number of lot panels and the tact time.

11. The method of claim 1, further comprising:
determining a spare time based on the first moving time and the limit waiting time,
wherein the spare time is determined by subtracting the first moving time from the limit waiting time.

12. The method of claim 1, further comprising:
determining a spare time based on the first moving time and the limit waiting time,
wherein as the spare time is shorter, the departure time is earlier.

13. The method of claim 1, wherein, when the estimated repair time is equal to or less than a first reference value, the reference automated guided vehicle waits at the destination point until the estimated repair time passes.

14. The method of claim 13, wherein, when the estimated repair time is greater than the first reference value and is less than or equal to a second reference value, the reference automated guided vehicle wanders around the destination point.

15. The method of claim 14, wherein, when the estimated repair time is greater than the second reference value, the reference automated guided vehicle moves to the starting point.

16. The method of claim 1, further comprising:
unloading an object at the destination point when the destination point facility is not out of order.

17. The method of claim 1, further comprising:
designating a limited number of the automated guided vehicles for each of routes from the current point to the destination point.

18. A departure management system of an automated guided vehicle comprising:
automated guided vehicles; and
a controller for communicating with the automated guided vehicles,
wherein the controller is configured to determine whether a task is assigned to a reference automated guided vehicle of the automated guided vehicles, extract a starting point and a destination point of the task when the task is assigned to the reference automated guided vehicle, estimate a first moving time which is a moving time of the reference automated guided vehicle from a current point of the reference automated guided vehicle to the destination point, and a limit waiting time, determine a departure time of the reference automated guided vehicle from the current point to the destination point based on the first moving time and the limit waiting time, determine whether a destination point facility is out of order, and determine a failure response command for the reference automated guided vehicle based on an estimated repair time of the destination point facility when the destination point facility is out of order.

19. The departure management system of claim 18, wherein the first moving time is estimated based on current locations and simulation times of the automated guided vehicles.

20. The departure management system of claim 18, wherein the limit waiting time is estimated based on a total number of lot panels and a tact time.
